(19) United States
(12) Patent Application Publication
(10) Pub. No.: US 2008/0192175 A1
(43) Pub. Date: Aug. 14, 2008

(54) LCD monitor having multiple background colors

(76) Inventor: Shih-Wen Hsiao, Tamtzu Hsiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/705,018

(22) Filed: Feb. 12, 2007

(51) Int. Cl. G02F 1/1335

(52) U.S. Cl. 349/62

(57) ABSTRACT

A LCD monitor, which has multiple light guides matched with a respective LED lamp and peripherally blocked with light blocking filters so that different background colors are shown in different display zones of the LCD panel thereof.

### BACKGROUND OF THE INVENTION

1. Field of the Invention

The present invention relates to LCD monitors and more particularly, to a LCD monitor that has multiple background colors.

2. Description of the Related Art

A regular LCD monitor has a reflector at the back side to reflect light from the backlight module, thereby enhancing the background light. However, the whole display panel of a conventional LCD monitor simply provided one background color, light grey or yellow. This monochromic background color is monotonous, showing little visual effect.

### SUMMARY OF THE INVENTION

The present invention has been accomplished under the circumstances in view. It is therefore the main object of the present invention to provide a LCD monitor, which shows different background colors in multiple display zones on the LCD panel. According to the present invention, the LCD monitor comprises a plurality of light guides arranged on a bottom side of a LCD panel thereof, multiple LED (light emitting diode) lamps respectively arranged at one side of each of the light guides and controllable to emit different colors of light to the light guides respectively for showing different background colors in different display zones on the LCD panel, and multiple blocking filters respectively attached to the periphery of the light guides to block the light of the LED lamps in the associating light guides respectively and to prohibit the light of each of the LED lamps from passing out of the associating light guide.

### BRIEF DESCRIPTION OF THE DRAWINGS

FIG. 1 is an exploded view of the preferred embodiment of the present invention.

FIG. 2 is a front view of the preferred embodiment of the present invention.

FIG. 3 is a sectional assembly view of the preferred embodiment of the present invention.

### DETAILED DESCRIPTION OF THE PREFERRED EMBODIMENT

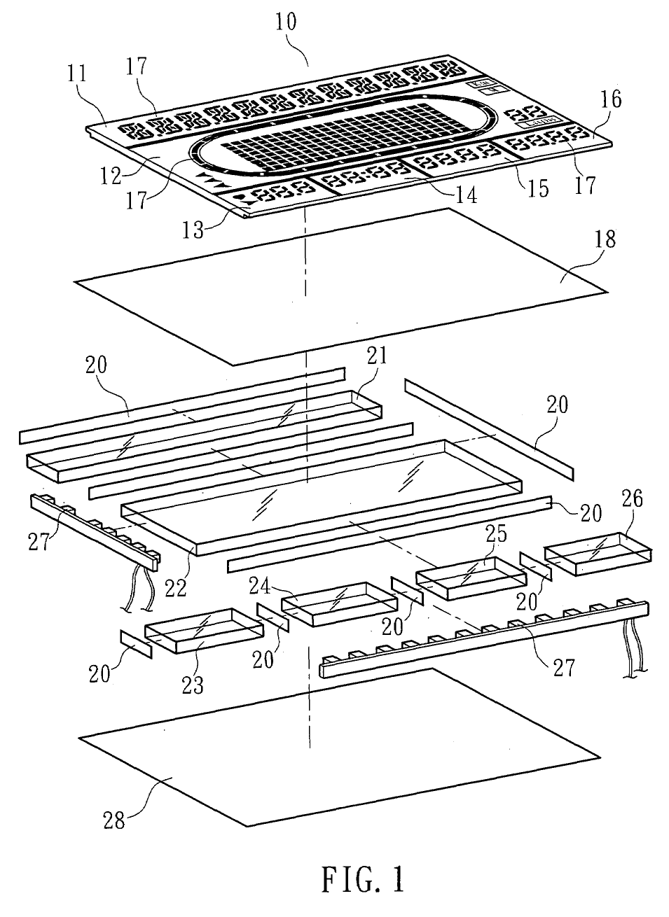

Referring to FIGS. 1˜3, a LCD monitor in accordance with the present invention is shown comprising a LCD panel 10, a plurality of light guides 21˜26 arranged on the bottom side of the LCD panel 10, multiple LED (light emitting diode) lamps 27 respectively arranged at one side of each of the light guides 21˜26 and controlled to emit different colors of light to the associating light guides 21˜26, and multiple blocking filters 20 respectively attached to the periphery of the light guides 21˜26 to block the light of the associating LED lamp 27 in the associating light guide and to prohibit the light of the associating LED lamp 27 from passing through the other light guides.

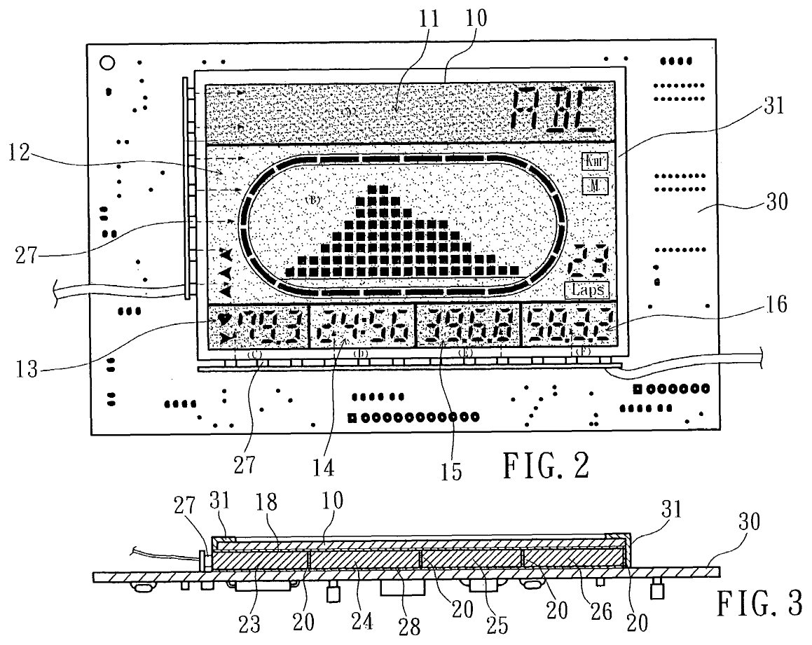

Referring to FIGS. 2 and 3 again, the light guides 21˜26, the blocking filters 20 and the LED lamp 27 are abutted against one another on a same plane, and then covered with a light diffuser film 18 at the top side and a light reflector film 28 at the bottom side, and then the LCD panel 10 is attached to the top side of the light diffuser film 18, and then the assembly thus obtained is installed in a circuit board 30 and packed in a frame 31. Thus, the LCD panel 10 and the LED lamps 27 are electrically connected to the circuit board 30, and the circuit board 30 provides the necessary working voltage to the LCD panel 10 and the LED lamps 27.

Further, the LCD panel 10 has multiple display zones 11˜16 corresponding to the light guides 21˜26. The display zones 11˜16 each has bright dots 17 controllable by the circuit board 30 to display or not to display letters or graphics (because the function of the bright dots of the LCD panel 10 to display or not to display is of the known art and not within the scope of the present invention, no further detailed description in this regard is necessary). For example, the first display zone 11 is adapted to display English letters; the second display zone 12 is adapted to display graphics; the third through sixth display zones 13˜16 are adapted to display numerals.

When the LED lamps 27 are turned on, the light of the LED lamps 27 passes through the associating light guides 21˜26, the light reflector film 28 reflects light toward the light diffuser film 18, and the light diffuser film 18 diffuses light into the whole area of the LCD panel 10. Further, the LED lamps 27 can be controlled to emit different colors of light into the associating light guides 21˜26. By means of the effect of the blocking filters 20, each of the light guides 21˜26 is illuminated with a respective color of light, and therefore the display zones 11˜16 of the LCD panel 10 show different background colors A˜F, showing a unique visual effect.

Although a particular embodiment of the invention has been described in detail for purposes of illustration, various modifications and enhancements may be made without departing from the spirit and scope of the invention.

What the invention claimed is:

1. A LCD monitor comprising a plurality of light guides arranged on a bottom side of a LCD panel thereof, multiple LED (light emitting diode) lamps respectively arranged at one side of each of said light guides and controllable to emit different colors of light to said light guides respectively for showing different background colors in different display zones on said LCD panel, and multiple blocking filters respectively attached to the periphery of said light guides to block the light of said LED lamps in the associating light guides respectively and to prohibit the light of each of said LED lamps from passing out of the associating light guide.
